(19) United States
(12) Patent Application Publication
(10) Pub. No.: US 2025/0357570 A1
(43) Pub. Date: Nov. 20, 2025

(54) POWER STORAGE APPARATUS

(71) Applicant: TOYOTA JIDOSHA KABUSHIKI KAISHA, Toyota-shi (JP)

(72) Inventors: Toshio UCHIYAMA, Toyota-shi (JP); Hiroki Yamauchi, Aichi-ken (JP)

(73) Assignee: TOYOTA JIDOSHA KABUSHIKI KAISHA, Toyota-shi (JP)

(21) Appl. No.: 19/289,519

(22) Filed: Aug. 4, 2025

(30) Foreign Application Priority Data
Apr. 30, 2024 (JP) 2024-148643

(51) Int. Cl. H01M 10/653; H01M 10/6554; H01M 10/6556; H01M 50/204

(52) U.S. Cl. CPC H01M 10/653; H01M 10/6554; H01M 10/6556; H01M 50/204

(57) ABSTRACT

To provide a power storage apparatus adapted to cover the side faces of battery modules with an insulation sheet while suppressing deterioration of the insulation sheet. According to the present disclosure, a power storage apparatus includes: a battery module, an insulation sheet, and a flow path. The insulation sheet covers side faces of the battery module. The flow path guides an airflow in the vicinity of the battery module and extends substantially parallel to the insulation sheet. With such a configuration, it is possible to suppress contact between the insulation sheet and air in the vicinity of the battery module that has risen in its temperature in the power storage apparatus according to the present disclosure. As a result, in the power storage apparatus according to the present disclosure, the side faces of the battery module can be covered with the insulation sheet while suppressing deterioration of the insulation sheet.

### CROSS REFERENCE TO RELATED APPLICATIONS

This application is based upon and claims the benefit of priority from Japanese patent application No. 2024-148643, filed on Aug. 30, 2024, the disclosure of which is incorporated herein in its entirety by reference.

### BACKGROUND

The present disclosure relates to a power storage apparatus.

Patent Literature 1 describes a power storage apparatus including a battery module, a control unit for the battery module, a rack in which the battery module and the control unit are disposed, and a cover for covering the rack.
[Patent Literature 1] Japanese Unexamined Patent Application Publication No. 2021-132006

### SUMMARY

A power storage apparatus according to Patent Literature 1 is configured such that when the outer cover is removed for maintenance, for example, the side faces of the battery module are exposed.

Since the battery module transmits and receives current to and from the outside, it is preferable that the workers do not touch the battery module as much as possible.

Here, in order to prevent the workers from contacting the battery module, there is a way of covering the side faces of the battery module with an insulation sheet. However, in the case where the insulation sheet is disposed inside the power storage apparatus, air that has risen in its temperature due to the battery modules may contact the insulation sheet, which may cause the insulation sheet to deteriorate.

The technique described in Patent Literature 1 does not solve any of the problems described above.

The present disclosure has been made in order to solve such problems, and an object of the present disclosure is to provide a power storage apparatus adapted to cover the side faces of battery modules with an insulation sheet while suppressing the deterioration of the insulation sheet.

According to the present disclosure, a power storage apparatus includes: a battery module, an insulation sheet, and a flow path. The insulation sheet covers side faces of the battery module. The flow path guides an airflow in the vicinity of the battery module and is configured to extend substantially parallel to the insulation sheet.

With such a configuration, contact between the insulation sheet and air in the vicinity of the battery module that has risen in its temperature can be suppressed in the power storage apparatus according to the present disclosure. As a result, the power storage apparatus according to the present disclosure can cover the side faces of the battery modules with an insulation sheet while suppressing deterioration of the insulation sheet.

The power storage apparatus according to the present disclosure may include at least one battery module and at least one support plate for supporting a bottom face of the battery module. The battery module and the support plate may be aligned in a vertical direction, and the flow path may be provided on a face of the support plate on a lower vertical direction side of the support plate.

With such a configuration, the flow path can be formed without having to increase the number of components, and thus, it is possible to keep down the manufacturing cost of the power storage apparatus according to the present disclosure.

In the power storage apparatus according to the present disclosure, the support plate may have a folded-plate structure. The flow path may be provided as a part of the folded-plate structure.

With such a configuration, since the flow path can be formed by a simple manufacturing process, it is possible to keep down the manufacturing cost of the power storage apparatus according to the present disclosure.

In the power storage apparatus according to the present disclosure, the insulation sheet may be disposed in the form of a hanging curtain covering side faces of the plurality of the battery modules.

With such a configuration, the side faces of a plurality of battery modules can be covered with an insulation sheet without having to increase the number of components, and thus, it is possible to keep down the manufacturing cost of the power storage apparatus according to the present disclosure.

According to the present disclosure, it is possible to provide a power storage apparatus adapted to cover the side faces of a battery module with an insulation sheet while suppressing deterioration of the insulation sheet.

The above and other objects, features and advantages of the present disclosure will become more fully understood from the detailed description given hereinbelow and the accompanying drawings.

### BRIEF DESCRIPTION OF DRAWINGS

FIG. 1 is a perspective view showing a configuration of a power storage apparatus according to a first embodiment;

FIG. 2 is a cross-sectional view showing the configuration of the power storage apparatus according to the first embodiment; and

FIG. 3 is a cross-sectional view showing the configuration of the power storage apparatus according to the first embodiment.

### DESCRIPTION OF EMBODIMENTS

### First Embodiment

### <Configuration of Power Storage Apparatus>

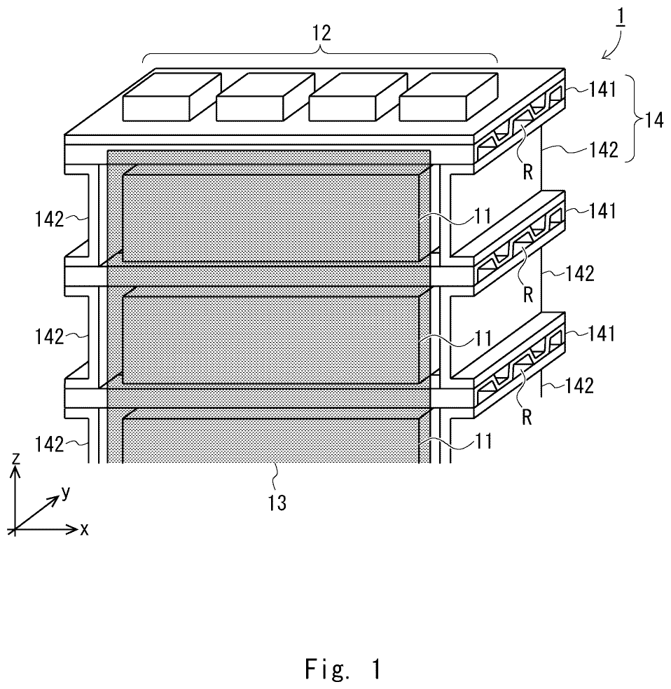

Hereinafter, a first embodiment according to the present disclosure will be described in detail with reference to the drawings. FIG. 1 is a perspective view showing a configuration of a power storage apparatus according to the first embodiment. More specifically, it is a perspective view illustrating the internal structure of a power storage apparatus 1.

Needless to say, the right-handed xyz orthogonal coordinates shown in FIG. 1 and other drawings are for the sake of convenience in illustrating the positional relationship of the structural elements/components. In the present embodiment, the z-axis positive direction in FIG. 1 and other drawings denotes the vertically-upward direction and the xy-plane denotes a horizontal plane, which are common throughout the drawings.

The power storage apparatus 1 is a stationary-type power storage apparatus. For example, the power storage apparatus 1 is installed in a house or the like, and is used to store power for household use, emergency backup power, power for sale, etc.

As shown in FIG. 1, the power storage apparatus 1 according to the present embodiment has an internal structure in which a plurality of battery modules 11 and a control unit 12 are housed in a rack 14 including an insulation sheet.

That is, the power storage apparatus 1 according to the present embodiment has the structure shown in FIG. 1 inside a housing (not shown), an outer cover (not shown), or both.

The plurality of the battery modules 11 in the power storage apparatus 1 are, for example, secondary batteries such as lithium-ion batteries and nickel-metal hydride batteries.

The battery modules 11 operate under the control of the control unit 12. Specifically, under the control of the control unit 12, the battery modules 11 receives power from the outside and store the supplied power. Then, under the control of the control unit 12, the battery modules 11 supply the stored power to the outside. In other words, the battery modules 11 send and receive power to and from the outside under the control of the control unit 12.

The battery modules 11 send and receive power to and from the outside via a wiring member, illustration of which is omitted in FIG. 1.

As shown in FIG. 1, the plurality of the battery modules 11 of the power storage apparatus 1 are housed in the rack 14 in the z-axis direction, that is, aligned in the vertical direction.

Here, among the faces parallel to the xy-plane, the faces of the battery modules 11 which are located on the z-axis negative-side, i.e., the bottom faces of the battery modules 11, are supported by support plates 141 to be described later.

In addition, among the faces parallel to the xy-plane, the faces of the battery modules located on the z-axis positive-side, i.e., the top faces of the battery modules 11, are covered with the support plates 141 different from the above-described the support plates 141.

Furthermore, the battery modules 11 have two side faces which are parallel to the yz-plane covered with sidewall plates 142 to be described later.

That is, the battery modules 11 are accommodated in a space defined by two support plates 141 and two sidewall plates 142.

Furthermore, at least one of the two faces of the battery modules 11 parallel to the zx-plane is covered with an insulation sheet 13. In other words, the battery modules 11 according to the present embodiment has one or more side faces covered with the insulation sheet 13.

The control unit 12 controls the operation of the power storage apparatus 1.

For example, the control unit 12 may control the amount of power supplied from the outside to the battery modules 11 and the amount of power supplied from the battery modules 11 to the outside.

In addition, the control unit 12 may monitor the temperature and voltage of the batteries, calculate the limit values of the voltage and current applied to the batteries, and perform communication with an external device.

For example, the control unit 12 includes an arithmetic unit such as a CPU (Central Processing Unit), which is not shown, and a storage unit such as RAM (Random Access Memory), ROM (Read Only Memory), or the like, which store programs and data for controlling the power storage apparatus 1. That is, the control unit 12 has a function as a computer and controls the operation of the power storage apparatus 1 based on the programs described above.

Therefore, each of the functions executed by the exemplified control unit 12 can be implemented by the CPU, the storage unit, and other circuits in terms of hardware, and can be implemented by programs for controlling the power storage apparatus 1 stored in the storage unit in terms of software. That is, the control unit 12 can be implemented in various forms by hardware, software, or a combination of both.

Such programs can be stored and supplied to a computer using any type of non-transitory computer-readable media. Non-transitory computer-readable media include various types of tangible recording media. Examples of non-temporary computer-readable media include magnetic recording media (For example, flexible disk, magnetic tape, hard disk drive), magneto-optical recording media (e.g., magneto-optical disks), CD-ROM (Read Only Memory), CD-R, CD-R/W, and semiconductor memory (For example, mask ROM, PROM (Programmable ROM), EPROM (Erasable PROM), flash ROM, RAM (Random Access Memory)). Programs can also be supplied to a computer by various types of transitory computer-readable media. Examples of transitory computer-readable media include electrical signals, optical signals, and electromagnetic waves. Transitory computer-readable media can supply programs to a computer via wired or wireless communication channels, such as wires and optical fibers.

The insulation sheet 13 is a sheet composed primarily of a material having electrical insulating properties, and covers the side faces of the battery modules 11.

As the main material of the insulation sheet 13, polyethylene, synthetic resins such as polyvinyl chloride, polystyrene, polyester, and polyamide can be used, for example.

The insulation sheet 13 according to the present embodiment is disposed in the form of a hanging curtain covering the side faces of the plurality of the battery modules 11.

In other words, the insulation sheet 13 according to the present embodiment is a substantially rectangular sheet whose one side is fixed to the upper side of the rack 14 to be described later, and extends in the z-axis negative direction, that is, in the vertically-downward direction, when viewed from the fixed side.

The insulation sheet 13 according to the present embodiment is disposed in parallel with the zx-plane, so that it is disposed substantially parallel with a flow path R to be described later.

The rack 14 has a shelf-shaped structure for accommodating the battery modules 11 and the control unit 12. The rack 14 has vertically-aligned rectangular-parallelepiped accommodation spaces capable of accommodating the battery modules 11, and at least one battery module 11 is accommodated in each accommodation space. The rack 14 has the control unit 12 installed in the top face thereof.

The rack 14 is housed in a housing (not illustrated) or in an exterior cover (not illustrated) of the power storage apparatus 1. The rack 14 is fixed to the installation face of the power storage apparatus 1 directly or via a housing.

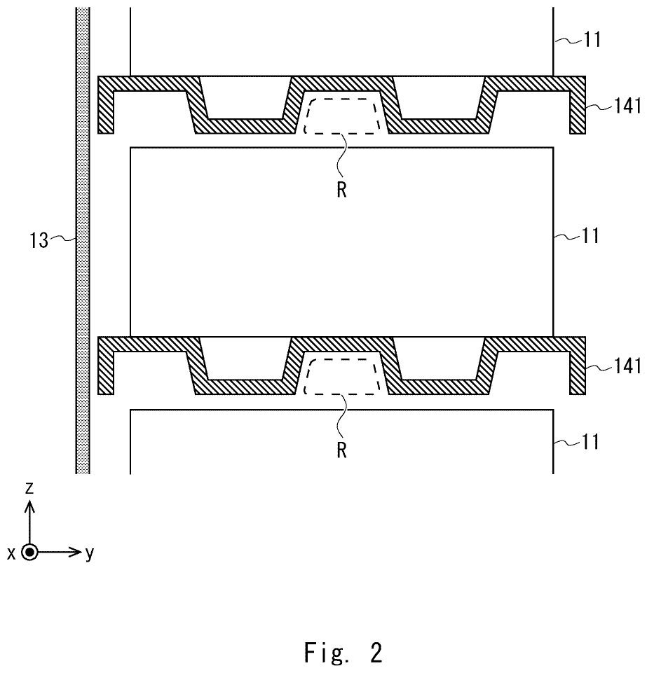

FIG. 2 is a cross-sectional view showing the configuration of the power storage apparatus according to the first embodiment. More specifically, FIG. 2 is a side face view of the battery modules 11, the support plate 141, and the insulation sheet 13 viewed from the x-axis positive direction, and a cross-sectional view showing the support plate 141 when taken along a plane parallel to the yz-plane.

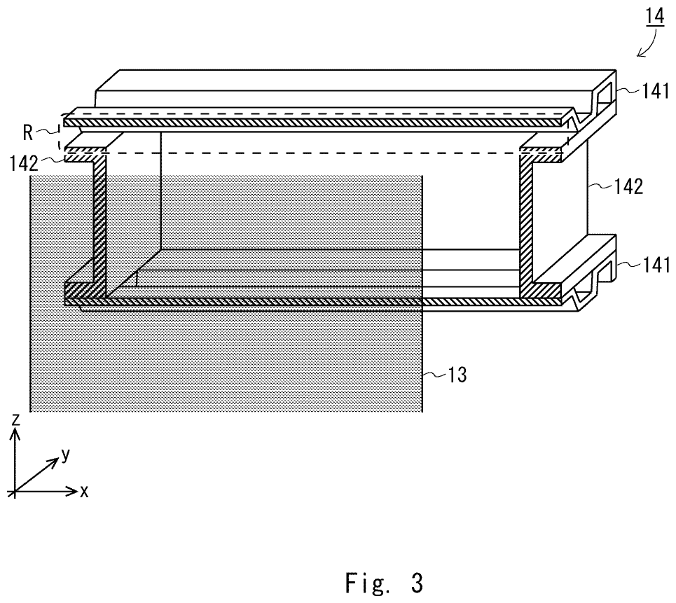

FIG. 3 is a cross-sectional view showing the configuration of the power storage apparatus according to the first embodiment. More specifically, FIG. 3 is a perspective view showing parts of the support plates 141, the sidewall plates 142, and the insulation sheet 13, and illustrates a cross-sectional view of the support plates 141 and the sidewall plates 142 when taken along a plane parallel to the zx-plane.

The rack 14 includes a plurality of the support plates 141 and the sidewall plates 142.

The support plate 141 is a plate-like member for supporting the bottom face of each of the battery modules. As shown in FIGS. 1, 2, and 3, the rack 14 according to the present embodiment has a plurality of the support plates 141, each of which supports either the bottom face of a battery module or the control unit.

More specifically, the support plate 141 located on the uppermost stage supports the control unit 12, and the other the support plates 141 support the battery modules 11.

As shown in FIGS. 1, 2, and 3, the plurality of the battery modules 11 and the support plates 141 are aligned in the z-axis direction, that is, in the vertical direction.

With this configuration, the support plates 141 cover the top face of the battery modules 11, that is, the face located on the z-axis positive-side among the faces parallel to the xy-plane. That is, the support plates 141 support the battery modules 11 on the z-axis positive-side, and cover the top face of the battery modules 11 on the z-axis negative-side.

As shown in FIGS. 1, 2, and 3, the support plates 141 have a folded-plate structure. With this configuration, the strength of the support plates 141 according to the present embodiment can be improved. In the support plates according to the present embodiment, a part of the folded-plate structure functions as the flow path R to be described later, the details of which will be described later.

The sidewall plates 142 are plate-like members connecting the two the support plates 141 and cover the side faces of the battery modules 11 as shown in FIG. 1. The two sidewall plates 142 are disposed for each battery module 11 and cover the side faces on the x-axis direction positive-side and the x-axis direction negative-side.

The flow path R has a groove structure for guiding the airflow in the vicinity of the battery modules 11 and extends substantially parallel to the insulation sheet 13.

More specifically, the flow path R has a groove structure for guiding the flow of air that has risen in its temperature due to the battery modules 11 to the outside of the rack 14. Therefore, the above-mentioned vicinity of the battery modules 11 may be a region where the temperature of air rises due to the battery modules 11, for example.

Note that the flow path R need not be a flow path for all the air in the vicinity of the battery modules 11. The flow path R may function as a flow path for discharging at least a part of the air in the vicinity of the battery modules 11, for example, the air in the vicinity of the faces of the battery modules facing each other, or in the case of the present embodiment, the air in the vicinity of the top face of the battery modules 11.

As shown in FIG. 3, the flow path R extends parallel to the x-axis and, substantially parallel to the insulation sheet 13, as described above.

With such a configuration, the power storage apparatus 1 according to the present embodiment can discharge air that has risen in its temperature due to the battery modules 11 to the outside of the rack 14 while suppressing contact between the air and the insulation sheet 13. As a result, in the power storage apparatus 1 according to the present embodiment, the side faces of the battery modules can be covered with the insulation sheet while suppressing deterioration of the insulation sheet 13.

Needless to say, substantially parallel does not mean parallel in a strict sense. As long as the insulation sheet 13 is not located on an extension line of the flow path R or on a tangent line, even in the case where the positional relationship between the insulation sheet 13 and the flow path R deviates from parallel in a strict sense, it is clear that they are included within the scope of the technical concept of this disclosure. In other words, substantially parallel herein means parallel in which the deviation is allowed within the range in which the purpose of suppressing contact between the insulation sheet and air that has risen in its temperature is achieved.

As described above, the flow path R is provided on a face of the support plate 141 on the lower vertical direction side of the support plate 141 as a part of the folded-plate structure of the support plate 141. That is, the flow path R in the present embodiment is realized as one or more of the groove structures formed by bending the support plate 141 into a linear uneven shape.

By providing the flow path R on the lower vertical direction side surface of the support plate 141 as described above, an increase in the number of components can be suppressed. As a result, it is possible to keep down the manufacturing cost of the power storage apparatus 1 according to the present embodiment.

Furthermore, with the above-described configuration, the flow path R can efficiently discharge air in the vicinity of the battery modules 11, which has risen in its temperature due to the battery modules 11 and rises in the vertical upward direction, to the outside of the rack 14.

Furthermore, by realizing the flow path R as folded-plate structure of the support plate 141 as described above, the flow path R can be formed by a simple manufacturing process. As a result, it is possible to keep down the manufacturing cost of the power storage apparatus 1 according to the present embodiment.

As described above, power storage apparatus according to the present embodiment includes the insulation sheet 13 and the flow path R, and they are positioned substantially in parallel. With such a configuration, the power storage apparatus according to the present embodiment can prevent air, which has risen in its temperature due to the battery modules 11, from contacting the insulation sheet 13. As a result, the power storage apparatus 1 according to the present embodiment can cover the faces of the battery modules while suppressing deterioration of the insulation sheet.

In addition, the power storage apparatus 1 according to the present embodiment is provided with the flow path R on the back face of the support plate 141, and further configures the flow path R as a part of the folded-plate structure of the support plate 141. With such a configuration, the power storage apparatus 1 according to the present embodiment can realize the flow path R with a simple configuration, whereby it is possible to keep down the manufacturing cost of the power storage apparatus 1.

Furthermore, in the power storage apparatus 1 according to the present embodiment, the insulation sheet 13 is disposed in the form of a hanging curtain. With such a configuration, the side faces of a plurality of the battery modules 11 can be covered with one insulation sheet in the power storage apparatus 1 according to the present embodiment, whereby an increase in the number of parts can be suppressed.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A power storage apparatus, comprising:
a battery module;
an insulation sheet covering side faces of the battery module; and
a flow path for guiding an airflow in the vicinity of the battery module,
wherein the flow path extends substantially parallel to the insulation sheet.

2. The power storage apparatus according to claim 1, wherein,
at least one battery module is installed,
at least one support plate for supporting a bottom face of the battery module is disposed,
the battery module and the support plate are aligned in a vertical direction, and
the flow path is provided on a face of the support plate on a lower vertical direction side of the support plate.

3. The power storage apparatus according to claim 2, wherein
the support plate has a folded-plate structure, and
the flow path is provided as part of the folded-plate structure.

4. The power storage apparatus according to claim 1, wherein the insulation sheet is disposed in the form of a hanging curtain covering side faces of the plurality of the battery modules.
